(19) United States
(12) Patent Application Publication
(10) Pub. No.: US 2017/0082195 A1
(43) Pub. Date: Mar. 23, 2017

(54) METHOD AND TOOL FOR MECHANICALLY ROUGHENING A CYLINDRICAL SURFACE

(71) Applicant: GÜHRING KG, Albstadt (DE)

(72) Inventor: Gerd HECKEL, Puschendorf (DE)

(73) Assignee: GÜHRING KG, Albstadt (DE)

(21) Appl. No.: 15/346,304

(22) Filed: Nov. 8, 2016

Related U.S. Application Data
(63) Continuation of application No. PCT/EP2015/060549, filed on May 13, 2015.

(30) Foreign Application Priority Data
May 13, 2014 (DE) 102014209054. 7

(51) Int. Cl. F16J 1/02; B21D 31/00; B23B 41/12

(52) U.S. Cl. CPC F16J 1/02; B23B 41/12; B21D 31/00; B23B 2215/242

(57) ABSTRACT

A method for mechanically roughening a cylindrical surface of a workpiece, e.g. the piston-bearing surface of a cylinder sleeve in a cylinder crankcase, by producing a defined microstructure of mutually crossing grooves, and by a groove forming tool, operating with or without material removal. A method in which in a first operation, a groove-forming tool is moved axially along the workpiece surface in such a way that at least one axial groove is machined into the workpiece surface; and in a second operation, following the first operation, the groove forming tool is rotated about the cylinder axis by a predefined rotational angle in the axial position reached in the first operation, whereby at least one circumferential groove crossing the axial groove is machined into the workpiece surface; and in a third operation following the second operation, the groove-forming tool is drawn back axially along the workpiece surface.

The invention relates to a method and tool for mechanically roughening a cylindrical surface of an in particular metallic workpiece, especially the piston bearing surface of a cylinder sleeve in a cylinder crankcase, by generating a defined microstructure of mutually crossing grooves as the adhesive base for a surface layer to be applied later, e.g., via thermal spraying.

As sufficiently known, tribologically highly stressed surfaces of mechanical workpieces, e.g., the piston bearing surfaces of cylinder sleeves, are mechanically roughened by means of non-cutting or cutting tools, so as to obtain a good adhesive base for a surface layer, e.g., to be applied via thermal spraying. In particular honing, cutting and/or molding tools are used as the roughening tools.

For example, such a method and tool is indicated in WO 2010/015229 A1. The latter proposes that a rotationally driven progressive tool that is moved with an axial feed be used to introduce a helically running groove structure into a cylindrical substrate surface with a helix pitch of approx. 0.7 mm, a shallow depth of 0.14 mm, for example, and a width of up to 0.18 mm, for example, wherein the groove cross section is successively machined to a final dimension by means of the progressive tool. In particular, the grooved structure is to be generated in such a way that a base groove with a groove base width smaller than the groove base width of the finished groove is initially incorporated or cut or molded into the substrate surface. The base groove is then further machined in a non-cutting or cutting manner, so as to produce a contour at least on one side or one flank of the groove incorporated into the substrate that is optimally prepared for the subsequent procedural step of thermal spraying. The two flanks of the groove can be machined in such a way as to yield a dovetailed undercut or dovetailed undercut constriction. These groove constrictions are intended to provide an unusually strong clamping between the substrate and coating. The goal of incrementally incorporating the groove structure is to ensure that constant forces arise in the teeth or blades of the progressive tool that subsequently engage each other. The progressive tool proposed in WO 2010/015229 A1 is characterized by a square molding and cutting plate, for example, with at least three teeth lying one behind the other like a comb, which incrementally incorporate a desired groove structure into the substrate surface. The tool can be designed as a molding, cutting or honing tool, or also as a tool that combines the different machining types—e.g., cutting and molding or honing and molding or cutting and honing. The groove structure is introduced by means of the progressive tool into the substrate surface via tool advancement, i.e., a forward movement by the tool. By contrast, the subsequent tool retraction, i.e., the backward movement of the tool, is an idle stroke, since no further machining of the groove structure takes place any longer.

Another method and tool for generating a helical groove structure in a base body is known from WO 2010/015229 A1. As opposed to WO 2010/015229 A1, WO 2008/034419 A1 proposes that the surface of a base body be machined by a tool exhibiting two mutually offset blades with the formation of a first or second undercut, wherein the undercuts introduced into the surface are to be oppositely oriented relative to each other. The undercuts can be generated by geometrically determined blades, for example with indexable cutting inserts, which are oriented to each other at varying setting angles on a shared or different tool carrier(s). The first undercut can form a saw tooth-like cross section, for example by having a blade of a helical cutting plate introduce an undercut, essentially triangular contour of a notch or cutting channel into the base body. For reasons of symmetry and to reduce the logistical outlay as relates to the tools, the second undercut is also to form a saw tooth-like cross section, which ultimately introduces a corresponding contour into the surface of the base body. If the two undercuts exhibit the same contour as desired, covering the two contours of the two cutting sections situated one after the other yields the desired contour with two oppositely aligned undercuts. The two cutting blades can be arranged on a shared tool carrier, wherein the feed rate is then selected in such a way that the second blade generates a cutting path with a fixed distance and at a fixed angle to the cutting path of the first blade, and only removes the share of material from the base body that had not yet been removed while drilling, turning or knocking or planing. If the undercuts are introduced into a cylindrical surface during a drilling or turning process, the cutting processes are performed similarly to a threaded section, in that the blades carry out a helical motion. In order to raise productivity and process safety, it is further provided that several blades of the same orientation be arranged on a tool carrier, and several spaced apart cutting paths of the same orientation be introduced during a cutting process. Similar to a multi-start thread, several undercuts or cutting paths are simultaneously introduced into the base body when all blades are engaged with the base body. The feed is here dimensioned in such a way that the blades do not engage into the cutting path of the leading blade or blades, but rather run offset thereto. This is intended to enable a significant shortening of the machining time per clamping operation. As an alternative thereto, WO 2008/034419 A1 proposes that the first undercut be introduced into the base body with a blade having a first orientation. The orientation of this blade is subsequently to be changed, for example by turning an indexable cutting insert around a fixed angle. Finally, the second undercut is to be introduced into the base body with an opposed orientation in a second cutting process, wherein the change in orientation between the forward stroke and return stroke can take place given a flat surface, so that there is no idle stroke. A change in orientation can here take place automatically. During a surface treatment of cylindrical surfaces, it should also be possible to introduce the second undercut during the return stroke of the drilling tool, for example, if necessary with a change in the rotational direction. Here as well, the first and second undercut should be able to overlap each other, so that a shared profile with two undercuts arises at the end of surface treatment.

DE 10314249 B3 also describes a method for preparing a surface, which is provided with a thermally sprayed layer for subsequent coating. In the method described, material is removed from the surface by cutting. While removing the material, the surface is provided with a relief comprised of crossing flutes. The flutes are generated by means of a milling ridge, which when introduced into a cylinder bore is twisted in and simultaneously moved downwardly along the cylinder or bore axis. Once the desired depth in the bore has been reached, the milling ridge is extracted along the bore axis, wherein it continues to be turned in the same rotational direction, thereby introducing crossing flutes into the surface.

Additional methods and/or tools for roughening cylindrical surfaces of metallic workpieces are known from DE 202009014180 U1, WO 2007/087989 A1, DE 19802842 A1, DE 10348419 B3, DE 19713519 A1, EP 1759133 B1, WO 02/40850 A1, U.S. Pat. No. 5,622,753 or DE 102006004769 A1.

All known methods and tools share in common that, in order to roughen the cylindrical surface to be coated, a defined, in particular dovetailed, undercut slot or groove structure is generated by moving a rotationally driven molding and/or cutting tool with an axial feed relative to the workpiece surface to be roughened. The rotational and axial movement of the tool relative to the workpiece surface results in a helical or crossing slot or groove structure on the workpiece surface. However, the calibration of forward and return movements of the tool required for this purpose demands a high outlay from the standpoint of both control technology and time, so that a microstructure to be generated can be manufactured with a constant quality and precision.

Against the backdrop of the discussed prior art, the object of the invention is to provide a method and tool for mechanically roughening a cylindrical surface of an in particular metallic workpiece, especially the piston bearing surface of a cylinder sleeve in a cylinder crankcase, e.g., comprised of cast aluminum, with which a defined microstructure of crossing grooves can be fabricated as the adhesive foundation for a surface layer to be applied later, e.g., via thermal spraying, both economically and reproducibly, with the lowest scatter.

This object is achieved by a method with the features in claim 1, or by a groove molding tool with the features in claim 10. Preferred embodiments are the subject of dependent claims.

Based on claim 1, a method according to the invention exhibits the following operations:
a) A first operation in which the groove molding tool is moved axially along the workpiece surface in such a way as to introduce at least one axial groove into the workpiece surface;
b) A second operation following the first operation, in which the groove molding tool in the axial position reached in the first operation is turned around the cylinder axis by a prescribed rotational angle, as a result of which at least one circumferential groove that crosses the axial groove is introduced into the workpiece surface, and
c) A third operation following the second operation, in which the groove molding tool is retracted axially along the workpiece surface.

According to the invention, the groove molding tool is moved strictly axially forward during the forward tool stroke, strictly turned in the second operation following the first operation, and strictly moved axially back in the third operation following the second operation, i.e., during the return tool stroke. The forward tool stroke in the first operation is preferably larger than the axial extension of the workpiece surface to be machined, so that the at least one axial groove introduced into the workpiece surface in the first operation extends over the entire length of the cylindrical workpiece surface, i.e., is axially continuous. The return workpiece stroke, i.e., the distance of the groove molding tool in the third operation, advantageously corresponds to the forward workpiece stroke, i.e., the distance of the groove molding tool in the first operation, so that the groove molding tool, after going through the first to third operations, again arrives at its starting point, at least in an axial projection as viewed in the forward tool stroke direction. The third operation can take place idly, i.e., without any further machining of the workpiece surface. As an alternative thereto, an axial groove formed in the first operation can be machined further, i.e., to a final dimension or final cross section.

In any event, the three operations of the method according to the invention involve strictly axial or rotational movements of the groove molding tool relative to the workpiece surface. These movements can be easily realized with the lowest time outlay from the standpoint of control technology. As a result, the method according to the invention yields a microgroove structure on the workpiece surface, which is defined by at least one axial groove and at least one circumferential groove running transverse to the at least one axial groove. The grooves forming the microstructure have a very small depth, e.g., ranging from 0.05 to 0.15 mm, roughly from 0.05 to 0.07 mm, in particular measuring roughly 0.06 mm, and width, e.g., ranging from 0.10 to 0.20, roughly 0.13 to 0.17 mm. As opposed to the cross relief type microstructure known from DE 10314249 B3, for example, the at least one axial groove and at least one circumferential groove cross each other at a right angle.

The roughening method, which in the simplest case consists of precisely the first to third operations, can be given an especially economical design with the lowest time outlay, because the movements (forward stroke, rotation, return stroke) of the groove molding tool can be reduced to axial or rotational movements of the groove molding tool that are easy to manage with control technology. If no further machining takes place in the third operation, the return tool stroke can be performed at a higher speed than the forward tool stroke, making it possible to keep the time outlay for implementing the method according to the invention low. According to the invention, then, a defined microgroove structure with the lowest scatter can be reproducibly and economically manufactured, which enables an optimal adhesion or toothing for a surface layer, for example to be applied via thermal spraying, in both the axial direction and circumferential direction.

The microgroove structure can be shaped by cutting and/or without cutting. Therefore, the groove molding tool used for this purpose can be designed as purely a shaping or cutting tool, or as a tool that combines the aforementioned machining types of cutting (e.g., by clearing, punching, engraving, milling, honing, etc.) and shaping (via embossing, impressing). These machining types can be easily realized by providing corresponding toothed contours on the groove molding tool that are intricately configured to reflect the desired cross sectional dimensions of the axial and circumferential grooves.

For example, the groove molding tool can be designed in such a way that at least one axially parallel running row of teeth comprised of teeth arranged one after the other in the axial direction are arranged on a carrier body in conformity with the number of axial grooves to be generated in the first operation as well as their radial length and distribution around the cylinder axis to form the axial and circumferential grooves. The term “tooth” generally refers to a tooth-shaped contour for forming an axial or circumferential groove, and thus applies to each of the aforementioned non-cutting and cutting machining processes. Therefore, a “tooth” has a geometrically defined or geometrically undefined blade for groove machining with cutting, e.g., resembling a tusk of a groove slotting tool, a cutting tooth, a broaching needle or a honing stone of a honing tool, etc., or a contour for a machining the grooves of the workpiece material by shaping and not cutting. The teeth arranged in one and the same axial row can be formed on one or several elements arranged axially one after the other, e.g., inserts, plates, strips or the like, which can be exchanged via bolting, clamping, bonding, soldering, etc. on the carrier body, or are permanently secured in place. These elements are preferably arranged in receiving pockets open to the outer periphery on the outer periphery of the carrier body, and bolted to the carrier body or clamped against the carrier body. The axial teeth used to generate an axial groove and the circumferential tooth or teeth used to generate a circumferential groove are advantageously formed on various elements.

The groove molding tool can thus exhibit one or several axial rows of teeth, which in their axially parallel arrangement each encompass one or more teeth for generating an axial groove (axial teeth), as well as one or several teeth for generating one or several circumferential grooves (circumferential teeth). In cases where one and the same row of teeth is provided with several axial teeth, the latter are axially staggered as in a progressive tool in such a way as to successively form an axial groove to a prescribed final dimension and/or a prescribed final cross section. The successive formation of the axial groove cross section makes it possible to ensure that the axial teeth that sequentially engage the workpiece do not become excessively loaded. As opposed to the axial teeth, each circumferential tooth of a row of teeth comprises another circumferential groove. In a case where several circumferential teeth are provided in one and the same row of teeth, the latter are arranged in a comb-like manner. However, each circumferential tooth is configured in such a way that, as viewed in an axial projection in the forward tool stroke direction, it lies within the cross section of the axial groove that forms the leading axial tooth/teeth in the forward tool stroke direction, or expressed differently, that the cross section of each circumferential tooth, as viewed in an axial projection in the forward tool stroke direction, lies within the cross section formed by the axial tooth/teeth.

The movements of the groove molding tool discussed above can be executed and controlled relatively easily with a conventional NC or CNC-controlled machine tool. To this end, the carrier body of the groove molding tool can exhibit a clamping shaft, e.g., a known HSK, SK or cylinder shaft, with which the groove molding tool can in a known manner be joined to a separation point or interface of a modular machine tool system, for example.

In claim 2 of the method according to the invention, the forward tool stroke can be larger in the first operation than the axial extension of the workpiece surface to be machined. If the forward tool stroke in the first operation is larger than the axial extension of the workpiece surface to be machined, the at least one axial groove generated in the process always extends over the entire length of the workpiece surface. At the same time, the axial tooth/teeth of the groove molding tool is/are allowed to be axially outside of the workpiece, and hence not engaged with the workpiece, at the end of the first operation. The circumferential grooves can then be formed over only the circumferential teeth lying axially behind the axial tooth/teeth. As a result, the axial tooth/teeth lie(s) completely outside of the cylindrical surface while turning the groove molding tool, and is/are hence not exposed to stress any more.

In addition, according to claim 3, the prescribed rotational angle mentioned above can measure an integral multiple of an angle obtained from dividing 360° as the dividend and the number of the at least one axial groove as the divisor. While rotating the groove molding tool by 360°, for example, each axial groove formed in the first operation is again run through. Regardless of the number of axial grooves, a 360° rotation ensures that the at least one circumferential groove will always form a closed circular ring.

According to claim 4, in the event of several axial grooves, the latter can be preferably equidistantly distributed around the cylinder axis in the circumferential direction.

According to claim 5, at least one pair of diametrically opposing axial grooves can be molded into the workpiece surface in the first operation. In this case, then, the groove molding tool has at least one pair, preferably two or three pairs, of diametrically opposing rows of teeth on the carrier body, which are preferably equidistantly distributed around the cylinder axis in the circumferential direction. In total, then, two, four, six, etc. axial rings can be generated simultaneously in the first operation. Various, in particular two, diametrically opposing rows of teeth can here be axially arranged and configured in such a way that the circumferential teeth of the various, in particular the two, diametrically opposing rows of teeth form the same circumferential groove(s).

According to claim 6, the prescribed rotational angle can preferably measure 180° or 360°.

By turning the groove molding tool by 180°, each of the two diametrically opposing axial grooves formed in the first operation are again run through in the third operation, but by another row of teeth of the groove molding tool. For this reason, the diametrically opposing axial grooves can be successively molded to a prescribed final dimension or prescribed final cross section, for example a dovetailed cross section, in the first and third operation by two different rows of teeth. For example, the one of the two rows of teeth can form the one flank of each axial groove, and the other of the two rows of teeth can form the other flank of each axial groove.

As an alternative thereto, the two axial grooves can already be molded toward the same prescribed final dimension or the same prescribed final cross section in the first operation. In this case, the groove molding tool can be turned by 180° or 360° in the second operation.

Due to the 360° rotation, the groove molding tool always has the same rotational position at the end of the second operation as at the end of the first operation or before the second operation. However, since each circumferential tooth performs a 360° rotation, it is possible to successively mold one and the same circumferential groove toward a prescribed final dimension or a prescribed final cross section by means of the circumferential teeth of two diametrically opposed rows of teeth. For example, a circumferential tooth of the one row of teeth can machine the one of the two flanks of a circumferential groove, and a circumferential tooth of the other row of teeth can machine the other of the two flanks of the same circumferential groove.

According to claim 7, the axial and/or circumferential grooves can be successively molded toward a defined final dimension or a defined final cross section.

According to claim 8, the axial and/or circumferential grooves can here be given a dovetailed undercut.

According to claim 9, the method according to the invention can exhibit a fourth operation d), in which the groove molding tool is again turned relative to the workpiece around the cylinder axis of the workpiece surface by a prescribed rotational angle differing from the rotational angle of the second operation. The first to third operations can subsequently be performed once again. As a result, additional axial groove pairs can be generated.

According to claim 10, a groove molding tool according to the invention has a carrier body that carries at least one axially parallel row of teeth, wherein the at least one row of teeth encompasses at least one axial tooth to form an axial groove and at least one circumferential tooth to form one or more circumferential grooves, both arranged one after the other in an axial direction, and the cross section of each circumferential tooth as viewed in an axial projection in the forward tool stroke direction lies within the cross section of the at least one axial tooth.

According to claim 11, the at least one axial tooth as viewed in an axial projection in the forward tool stroke direction exhibits a dovetailed cross section.

According to claim 12, at least two axial teeth are provided, which are axially staggered and whose cross sections overlap as viewed in an axial projection in the forward tool stroke direction to form a defined, preferably dovetailed, overall cross section. For example, the two axial teeth each form a flank of the axial groove. As an alternative thereto, the at least two axial teeth can successively mold the axial groove toward a prescribed final dimension (depth, width) and/or a prescribed final cross section.

According to claim 13, the teeth arranged in one and the same row of teeth are preferably formed on one or several tooth elements arranged axially one after the other, which are detachably or permanently secured to the carrier body.

According to claim 14, the at least one axial tooth and the at least one circumferential tooth are preferably formed on various tooth elements. In this way, the various tooth contours can be fabricated more easily.

According to claim 15, the groove molding tool can have several rows of teeth, which are preferably equidistantly distributed in the circumferential direction of the groove molding tool.

According to claim 16, the at least one circumferential tooth can exhibit a dovetailed cross section as viewed in the circumferential direction.

According to claim 17, the groove molding tool can exhibit at least one pair of diametrically opposed rows of teeth.

According to claim 18, the cross section of at least one circumferential tooth of one of the two rows of teeth and the cross section of at least one circumferential tooth of the diametrically opposing other of the two rows of teeth can overlap as viewed in the circumferential direction to form a defined, preferably dovetailed, overall cross section. Similarly to the above description of the staggered axial teeth, two circumferential teeth of diametrically opposing rows of teeth can each form a flank of one and the same circumferential groove.

According to claim 19, the groove molding tool can additionally exhibit a clamping shaft, e.g., an HSK, SK or cylinder shaft, for joining the groove molding tool to a separation point or interface of an NC or CNC-controlled machine tool system, for example.

A method according to the invention and a groove molding tool according to the invention will be introduced below using the attached drawings, in which:

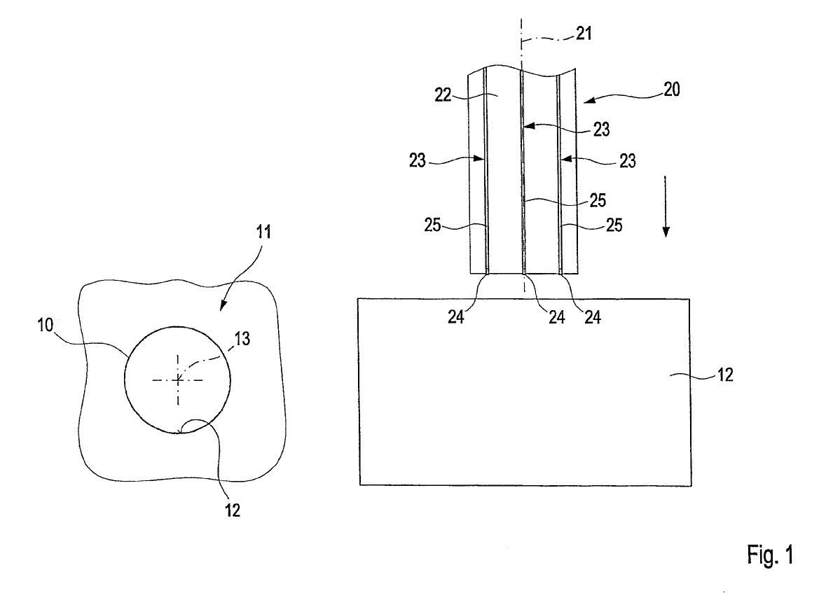

FIG. 1 presents a highly simplified sketch of an initial state;

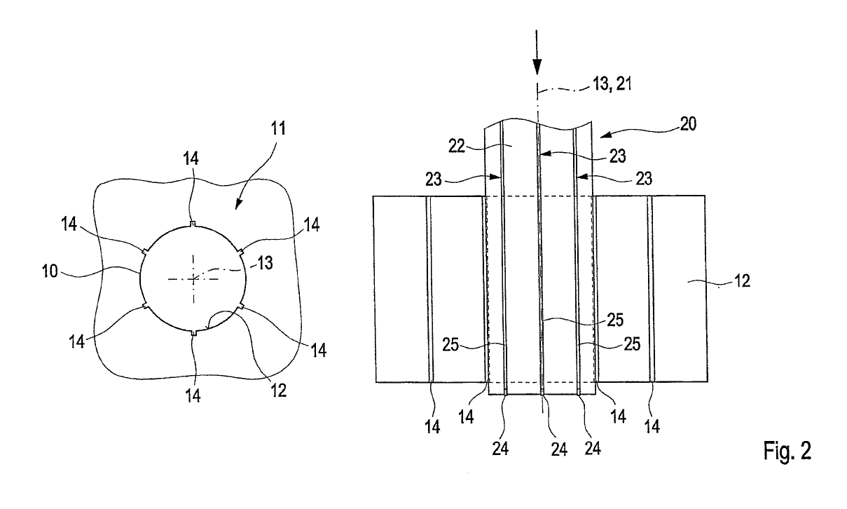

FIG. 2 presents a highly simplified sketch of a first operation of the method according to the invention;

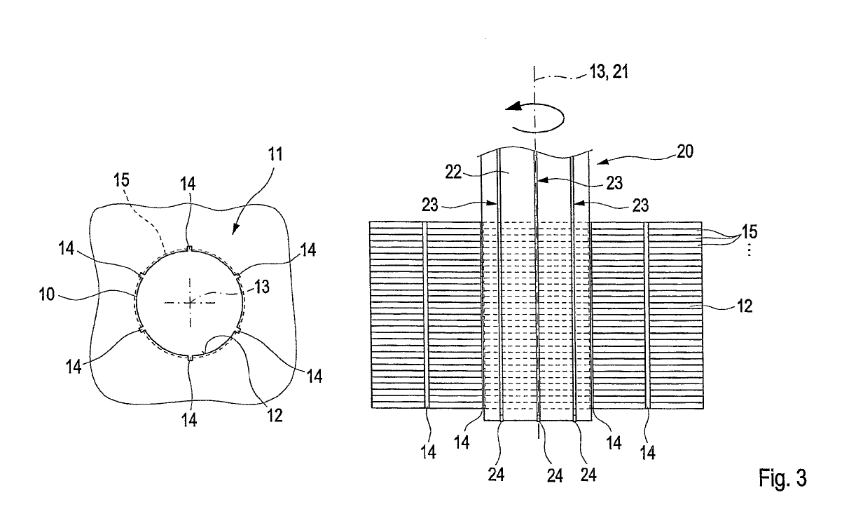

FIG. 3 presents a highly simplified sketch of a second operation of the method according to the invention;

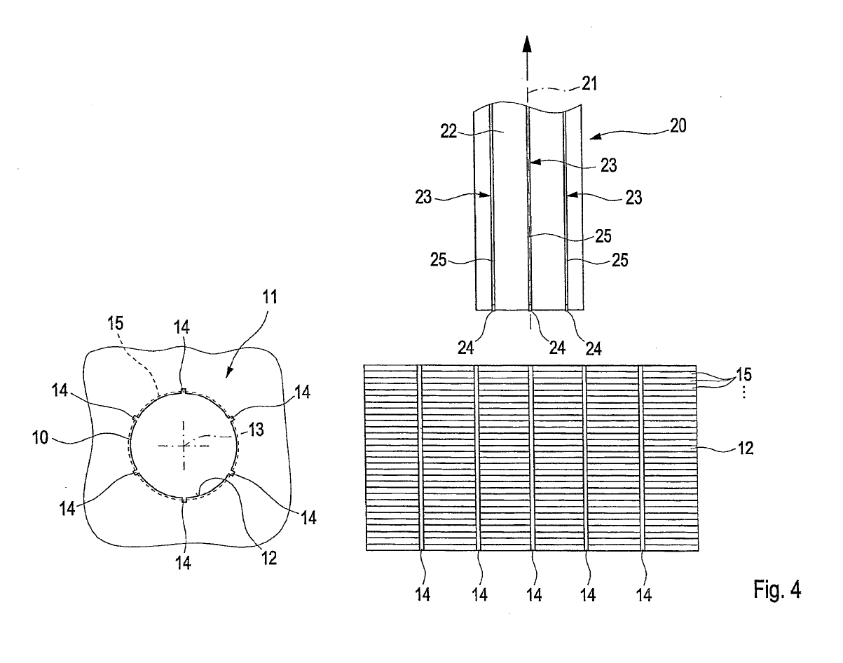

FIG. 4 presents a highly simplified sketch of a third operation of the method according to the invention;

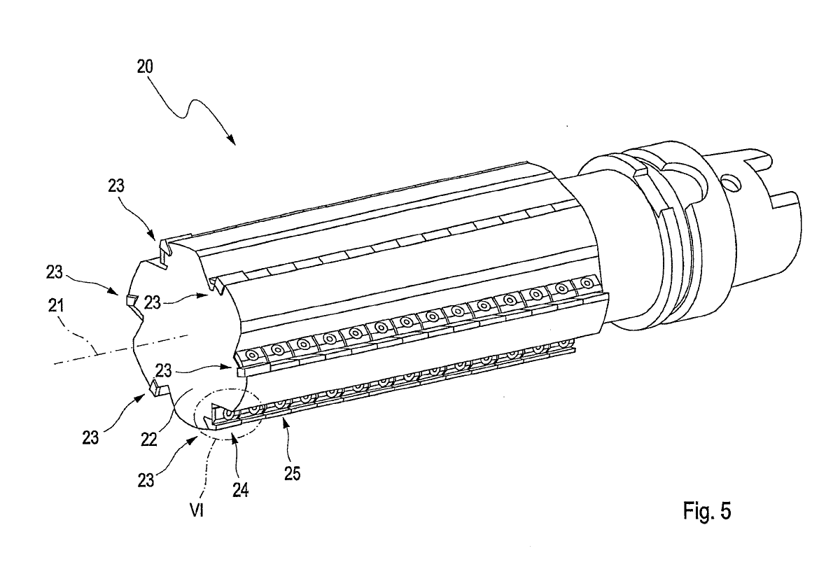

FIG. 5 shows a simplified, perspective view of an exemplary embodiment of a groove molding tool according to the invention for implementing the method sketched on FIGS. 1 to 4;

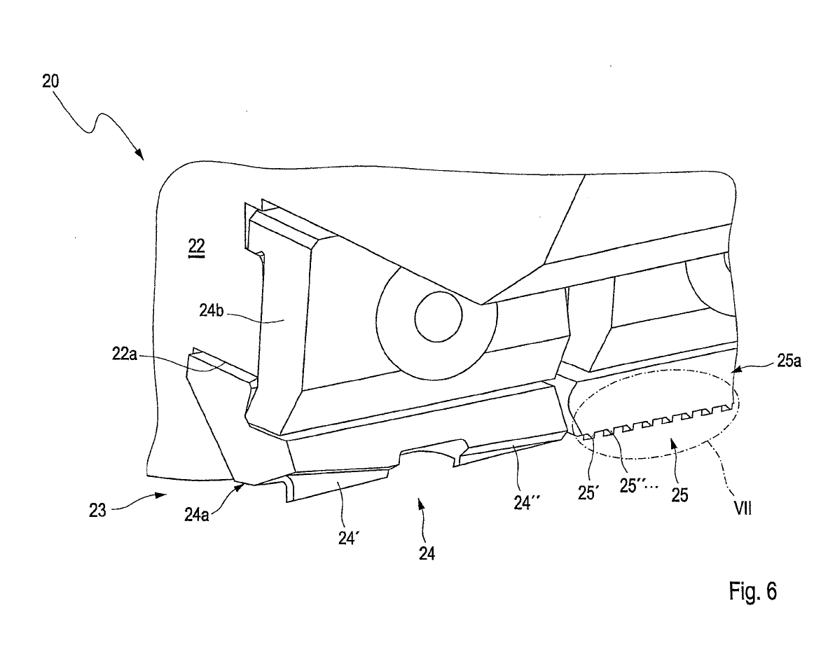

FIG. 6 shows a magnified view of a region of an axial tooth longitudinal section denoted with dashed lines on FIG. 5;

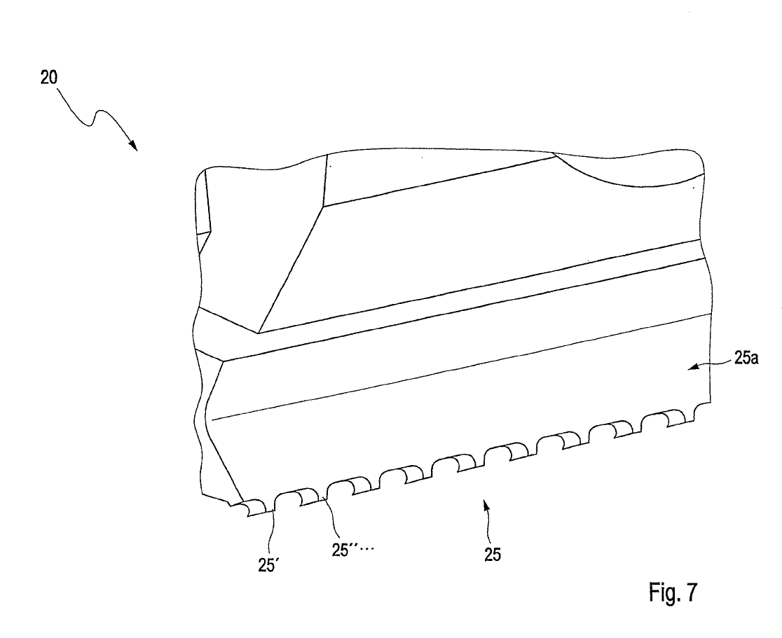

FIG. 7 shows a magnified view of a circumferential tooth longitudinal section denoted with dot-dashed lines on FIG. 6;

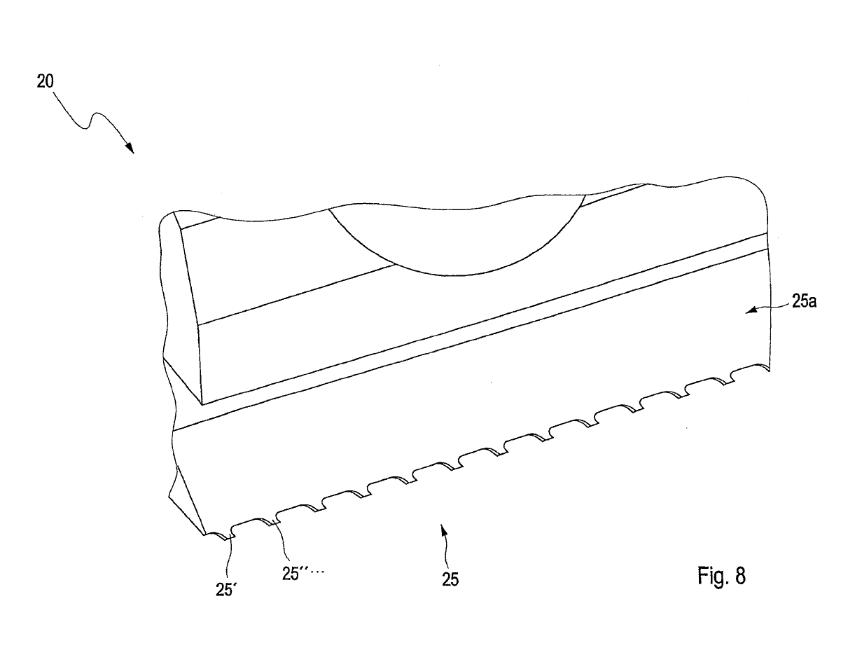

FIG. 8 shows another circumferential tooth longitudinal section, similarly to FIG. 7;

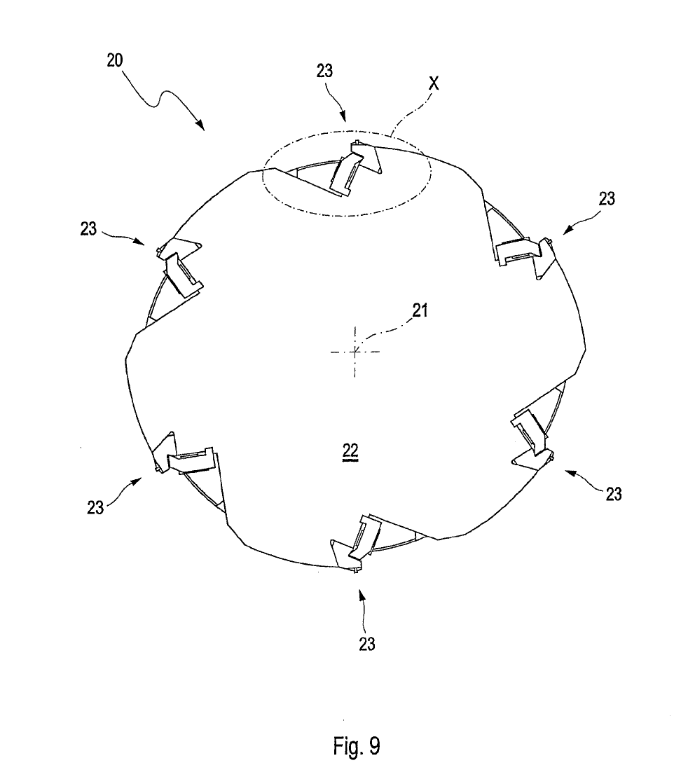

FIG. 9 shows a front view of the groove molding tool from FIG. 5; and

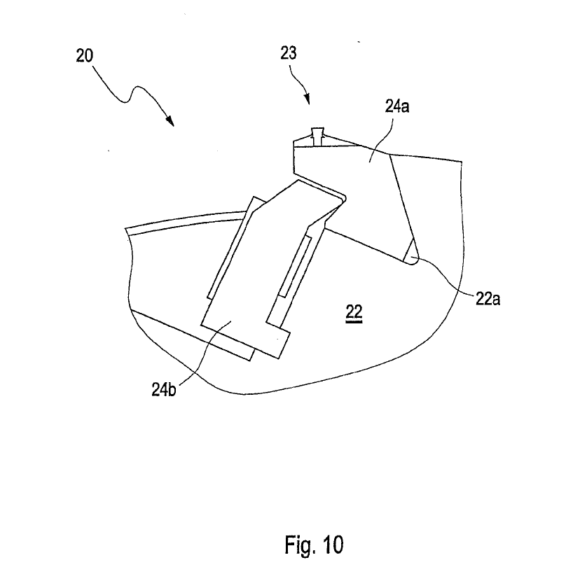

FIG. 10 shows a magnified view of a front section denoted with dot-dashed lines on FIG. 9.

In the following, FIGS. 1 to 4 will first be used to outline the essential operations of a method according to the invention, and also to introduce the basic structure of a groove molding tool according to the invention.

FIG. 1 shows an initial state. Visible on the bottom left is a highly simplified top view of a cylinder sleeve 10 of a cylinder crankcase 11 (workpiece). The inner surface 12 of the cylinder sleeve 10 comprises the surface to be roughened. FIG. 1 further shows a developed view of the inner surface 12 of the cylinder sleeve 10 on the bottom right, and a schematized view of a groove molding tool 20 on the top right. In the initial state sketched on FIG. 1, the groove molding tool 20 is positioned axially above the cylinder sleeve 10, specifically in such a way that the longitudinal center line 21 of the groove molding tool 20 coincides with the cylinder axis 13 of the cylinder sleeve 10, or expressed differently, the groove molding tool 20 is aligned coaxially to the cylinder sleeve 10.

In the exemplary embodiment shown on FIG. 1, the groove molding tool 20 has six rows of teeth 23, of which three are visible on FIG. 1. The rows of teeth 23 are arranged on a central carrier body 22, parallel to the longitudinal center line 21. The number, radial position and circumferential distribution of the rows of teeth 23 in relation to the longitudinal center line 21 corresponds to the axial grooves to be introduced into the inner surface 12. In terms of function, each of the rows of teeth 23 can be divided into two longitudinal sections 24 and 25. The front longitudinal section 24 as viewed in the forward tool stroke direction (see arrow on FIG. 1) encompasses at least one tooth to form an axial groove (hereinafter: axial tooth or axial teeth), while the longitudinal section of each row of teeth 23 lying behind the longitudinal section 24 as viewed in the forward tool stroke direction encompasses at least one, but normally a plurality of teeth to form a corresponding plurality of circumferential grooves (hereinafter: circumferential tooth or circumferential teeth). Reference numbers 24 and 25 on FIG. 1 thus indicate at least one axial tooth or at least one circumferential tooth.

In a case where several, for example two, axial teeth are provided in one and the same row of teeth, the latter are axially staggered one after the other just as in a progressive tool so as to successively form one and the same axial groove to a prescribed final dimension and/or a prescribed final cross section. For example, the several axial teeth can be designed in such a way as to successively form an axial groove toward a prescribed radial depth and/or circumferential width. Simultaneously or alternatively, the several axial teeth can be configured in such a way as to successively form the groove flanks of the axial groove toward a prescribed final cross section. As sketched on FIGS. 2 to 4, the final cross section can have a simple rectangular design, or exhibit a dovetailed undercut, for example. An undercut cross section can help achieve a better toothing for a surface coating with the cylinder sleeve 10 to be applied to the roughened inner surface 12 at a later time.

As opposed to the axial teeth, each circumferential tooth of a row of teeth forms another circumferential groove, as has yet to be explained drawing upon FIGS. 3 and 4. In the event that several circumferential teeth are provided in one and the same row of teeth 23, they are arranged one after the other like a comb. However, each circumferential tooth is designed in such a way, as viewed in an axial projection in the forward tool stroke direction, that its cross section lies within a cross section of the at least one axial tooth. In the case where one row of teeth 23 has exactly one axial tooth, the cross section of each ensuing circumferential tooth as viewed in the axial projection thus lies within the cross section of the one axial tooth. In the case where a row of teeth 23 has several axial teeth, the cross section of each ensuing circumferential tooth lies within a cross section referred to as the overlapping cross section, which as viewed in the axial projection results from an overlapping of cross sections of each of the several axial teeth. This measure ensures that the circumferential tooth/teeth do(es) not collide with the cylinder sleeve 10, i.e., the workpiece, during the purely axial movement of the groove molding tool 20 performed in the first operation, but instead run(s) within the axial groove that the at least one leading axial tooth in the forward tool stroke direction has already formed.

The above notwithstanding, the circumferential teeth in a row of teeth can have basically the same, but also differing cross sections. In terms of having a good toothing with a surface coating to be applied to the inner surface 12 at a later time, it can be advantageous for the circumferential teeth to have a dovetailed cross section. However, dovetailed undercut circumferential grooves can also be generated by having the circumferential teeth of two diametrically opposing rows of teeth be oppositely oriented, and thereby each form one of the two flanks of a respective circumferential groove during a 360° rotation.

Important to remember in this conjunction is that the term “tooth” generally refers to a tooth-shaped contour on the groove molding tool for forming an axial or circumferential groove, regardless of whether the tooth in question is configured for non-cutting and cutting machining processes. Therefore, a “tooth” has a geometrically defined or geometrically undefined blade for groove machining with cutting, e.g., resembling a tusk of a groove slotting tool, a cutting tooth, a broaching needle or a honing stone of a honing tool, etc., or a contour for machining by shaping and not cutting. For this reason, the microgroove structure to be formed on the inner surface 12 of the cylinder sleeve 11 with the method according to the invention can basically be formed without cutting and/or by cutting. Therefore, the groove molding tool 20 can be designed as purely a shaping or cutting tool, or as a tool that combines the aforementioned machining types of cutting (e.g., by clearing, punching, engraving, milling, honing, etc.) and shaping (via embossing, impressing).

The teeth situated in one and the same axial row can be located on one or several elements arranged axially one after the other, e.g., inserts, plates, strips or the like, which can be exchanged via bolting, clamping, bonding, soldering, etc. on the carrier body 22 of the groove molding tool 20, or are permanently secured in place. These elements are preferably arranged in receiving pockets open to the outer periphery on the carrier body 22, and bolted with the carrier body 22 or clamped against the carrier body 22. The at least one axial tooth and the at least one circumferential tooth are advantageously formed on various, separate elements.

In the initial state shown on FIG. 1, the inner surface of the cylinder sleeve 10 has still not been machined.

In the first operation of the method according to the invention sketched on FIG. 2, the groove molding tool 20 is moved axially along the inner surface 12 of the cylinder sleeve 10 in the forward tool stroke direction denoted by the arrow, causing the at least one axial tooth of each row of teeth 23 to form an axial groove 14 on the inner surface 12. According to the invention, the groove molding tool 20 is moved downwardly until such time that at least just the one axial tooth on FIG. 1b is positioned axially outside of the cylinder sleeve 10 at the end of the movement or the first operation, as visible on FIG. 2. Therefore, the forward tool stroke is larger than the axial extension of the cylinder sleeve 10 or the inner surface 12 to be machined. The axial grooves 14 are thus continuous. They extend over the entire length of the cylinder sleeve 10 or inner surface 12. FIG. 2 shows the result of the first operation. Visible corresponding to the number of rows of teeth 23 are six axial grooves, each with a rectangular cross section per the graphic depiction.

FIG. 3 sketches the second operation that follows the first operation, in which the groove molding tool 20 in the axial position reached in the first operation Is turned around a prescribed rotational angle, 360° in the sketched example, around the cylinder axis 13 or longitudinal center line 21, as a result of which a number of circumferential grooves 15 corresponding to the number of circumferential teeth 25 is additionally introduced into the inner surface 12, crossing the axial grooves 14 at a right angle. FIG. 3 presents a highly simplified illustration of a plurality of circumferential grooves 15, which are annular in shape owing to the 360° rotation. Because the axial teeth 24 of each row of teeth 23 of the groove molding tool 20 are located axially outside, and hence not engaged with the cylinder sleeve 10 during the second operation, they are not exposed to any stress whatsoever. The circumferential grooves 15 are formed solely via the axial circumferential tooth/teeth 25. As mentioned above, once the circumferential teeth of two diametrically opposing rows of teeth 23 come to be oppositely oriented, the 360° rotation allows the circumferential teeth of the diametrically opposing rows of teeth 23 to each form one of the two flanks of a respective circumferential groove, e.g., with a dovetailed undercut.

FIG. 4 sketches the third operation that follows the second operation, in which the groove molding tool 20 in the rotational position reached in the second operation is axially retracted back into its initial position corresponding to the initial state along the inner surface 12 of the cylinder sleeve 10 in the return tool stroke direction denoted by the arrow.

In summation, according to the invention, the groove molding tool 20 is thus moved purely axially forward in the first operation, i.e., during the forward tool stroke, purely turned in the axial position achieved in the first operation during the second operation that follows the first operation, and moved purely axially back in the rotational position reached in the second operation during the third operation that follows the second operation, i.e., during the return tool stroke. The forward tool stroke in the first operation is preferably larger than the axial extension of the inner surface 12 to be machined, so that the at least one axial groove 14 introduced into the inner surface 12 in the first operation extends over the entire length of the cylindrical inner surface 12, i.e., is axially continuous. The return tool stroke, i.e., the distance of the groove molding tool 20 in the third operation, advantageously corresponds to the forward tool stroke, i.e., the distance of the groove molding tool 20 in the first operation, so that the groove molding tool, after going through the first to third operations, again arrives at its starting position. The third operation takes place idly in the sketched method, i.e., without any further machining of the inner surface 12.

Therefore, the three operations in the method according to the invention are characterized by purely axial or rotational movements of the groove molding tool 20 relative to the inner surface 12. These movements can be easily realized with the lowest time outlay from the standpoint of control technology. As a result, the method according to the invention yields a microgroove structure on the workpiece surface, which is defined by at least one axial groove and at least one circumferential groove running transverse to the at least one axial groove. The grooves forming the microstructure have a very small depth, e.g., ranging from 0.05 to 0.15 mm, roughly from 0.05 to 0.07 mm, in particular measuring roughly 0.06 mm, and width, e.g., ranging from 0.10 to 0.20, roughly 0.13 to 0.17 mm.

The movements of the groove molding tool 20 discussed above can be executed and controlled relatively easily with a conventional NC or CNC-controlled machine tool. To this end, the carrier body 22 of the groove molding tool 21 can further exhibit a clamping shaft not shown on FIGS. 1 to 4, e.g., a known HSK, SK or cylinder shaft, with which the groove molding tool 20 can in a known manner be joined to a separation point or interface of a modular machine tool system, for example.

FIGS. 5 to 10 present schematic views of an exemplary embodiment of a groove molding tool according to the invention for implementing the method sketched on FIGS. 1 to 4.

According to FIG. 6, the groove molding tool 20 has two axial teeth 24′ 24″ per row of teeth 23, which are axially staggered as in a progressive tool in such a way as to successively form one and the same axial groove toward a prescribed final dimension and/or a prescribed final cross section. In addition, the axial teeth 24′ 24″ are formed on a strip-shaped tooth element 24a, which is detachably fastened to the carrier body 22 via clamping with a clamping plate 24b. As further evident from FIG. 6, the strip-shaped tooth element 24a is arranged in a receiving pocket 22a open on the outer periphery on the carrier body 22, and bolted to the carrier body 22 or clamped against the carrier body 22. In the groove molding tool 20, a plurality of circumferential teeth 25′, 25″, etc. per row of teeth 23 is further formed on a strip-shaped tooth element 25a differing from the tooth element 24a, which similarly to the tooth element 24a is arranged in a receiving pocket open on the periphery on the carrier body 22 (not indicated in any more detail). As may be gleaned from FIG. 5, the groove molding tool 20 exhibits a plurality of such tooth elements 25a per row of teeth 23, with a respective plurality of circumferential teeth that are arranged in an axial row with the tooth element 24a.

As evident from FIG. 6, the axial and circumferential teeth 24, 25 of each row of teeth 23 of the depicted groove molding tool are designed as cutting teeth. For example, the axial teeth 24 are designed as a kind of broaching needle of a broaching tool. The groove molding tool 20 shown on FIGS. 5 and 6 thus represents a purely cutting tool with geometrically definite cutting contours.

FIGS. 7 to 10 present further views and sections of the groove molding tool.

As stated at the outset, however, the axial and/or circumferential teeth can also be designed for non-cutting machining, etc., as an alternative to the groove molding tool shown on FIGS. 5 to 10. In addition, the teeth arranged in one and the same axial row can be formed on one or several elements arranged axially one after the other, e.g., inserts, plates, strips or the like, which are exchangeable or permanently fastened to the carrier body via bolting, bonding, soldering, etc., instead of via clamping.

In addition, fewer or more rows of teeth can be provided instead of the depicted six rows of teeth 23, which can basically be circumferentially distributed equidistantly or unequally around the longitudinal center line of the groove molding tool. Depending on the number and distribution of rows of teeth, the rotational angle in the second operation can also differ from 360°. According to claim 4, in the event of several axial grooves, the latter can preferably be equidistantly distributed around the cylinder axis in the circumferential direction, as already explained at the outset.

Additional variations and modifications of the method and groove molding tool according to the invention may be derived by the expert from the feature combinations discussed at the outset and/or the feature combinations in the claims. Such variations and modifications are the subject matter of the invention, and can serve as the basis for subsequent claim formulations.

1. A method for mechanically roughening a cylindrical surface of a workpiece by generating a defined microstructure of mutually crossing grooves by means of a non-cutting or cutting groove molding tool, the method comprising:
a) in a first operation, moving the groove molding tool axially along the workpiece surface in such a way as to introduce at least one axial groove into the workpiece surface;
b) in a second operation following the first operation, the groove molding tool in the axial position reached in the first operation is turned around the cylinder axis by a prescribed rotational angle, as a result of which at least one circumferential groove that crosses the axial groove is introduced into the workpiece surface, and
c) in a third operation following the second operation, the groove molding tool is retracted axially along the workpiece surface.

2. The method according to claim 1, wherein the forward tool stroke is larger than the axial extension of the workpiece surface to be machined.

3. The method according to claim 1, wherein the prescribed rotational angle measures an integral multiple of an angle obtained from dividing 360° as the dividend and the number of the at least one axial groove as the divisor.

4. The method according to claim 1, wherein, in the event of several axial grooves, the latter is equidistantly distributed around the cylinder axis in the circumferential direction.

5. The method according to claim 1, wherein at least one pair of diametrically opposing axial grooves can be molded into the workpiece surface in the first operation.

6. The method according to claim 4, wherein the prescribed rotational angle measures 180° or 360°.

7. The method according to claim 1, wherein the axial and/or circumferential grooves are molded toward a defined final dimension or a defined final cross section.

8. The method according to claim 1, wherein the axial and/or circumferential grooves are given a dovetailed undercut.

9. The method according to claim 1, wherein:
d) in a fourth operation d), the groove molding tool is again turned relative to the workpiece around the cylinder axis of the workpiece surface by a prescribed rotational angle differing from the rotational angle of the second operation, and
e) the first to third operations are subsequently performed once again.

10. A groove molding tool for mechanically roughening a cylindrical surface of a workpiece, comprising a carrier body that carries at least one axially parallel row of teeth,
the at least one row of teeth encompassing at least one axial tooth to form an axial groove and at least one circumferential tooth to form one or more circumferential grooves, both arranged one after the other in an axial direction,
the cross-section of each circumferential tooth as viewed in an axial projection in the forward tool stroke direction lying within the cross-section of the at least one axial tooth.

11. The groove molding tool according to claim 10, wherein the at least one axial tooth as viewed in an axial projection in the forward tool stroke direction comprises a dovetailed cross-section.

12. The groove molding tool according to claim 10, wherein the groove molding tool comprises at least two axial teeth, which are axially staggered and whose cross-sections overlap as viewed in an axial projection in the forward tool stroke direction to form an overlapping cross-section.

13. The groove molding tool according to claim 10, wherein the teeth arranged in one and the same row of teeth are formed on one or several tooth elements arranged axially one after the other, which are detachably or permanently secured to the carrier body.

14. The groove molding tool according to claim 13, wherein the at least one axial tooth and the at least one circumferential tooth are formed on various tooth elements.

15. The groove molding tool according to claim 10, wherein the groove molding tool comprises several rows of teeth.

16. The groove molding tool according to claim 10, wherein the at least one circumferential tooth comprises a dovetailed cross section as viewed in the circumferential direction.

17. The groove molding tool according to claim 10, wherein the groove molding tool comprises at least one pair of diametrically opposed rows of teeth.

18. The groove molding tool according to claim 17, wherein the cross-section of at least one circumferential tooth of one of the two rows of teeth and the cross-section of at least one circumferential tooth of the diametrically opposing other of the two rows of teeth overlap as viewed in the circumferential direction.

19. The groove molding tool according to claim 10, wherein the groove molding tool comprises a clamping shaft for clamping the groove molding tool to a separation point or interface of a machine tool system.

20. The method according to claim 1, wherein the workpiece is metallic.

21. The method according to claim 1, wherein the cylindrical surface is a piston bearing surface of a cylinder sleeve in a cylinder crankcase.

22. The groove molding tool according to claim 12, wherein the overlapping cross-section is undercut.

23. The groove molding tool according to claim 12, wherein the overlapping cross-section is dovetailed.

24. The groove molding tool according to claim 15, wherein the several rows of teeth are equidistantly distributed in a circumferential direction of the groove molding tool.

25. The groove molding tool according to claim 17, wherein the cross section of at least one circumferential tooth of one of the two rows of teeth and the cross section of at least one circumferential tooth of the diametrically opposing other of the two rows of teeth overlap as viewed in the circumferential direction to form a dovetailed, overall cross section.
